(19) United States
(12) Patent Application Publication
(10) Pub. No.: US 2021/0149576 A1
(43) Pub. Date: May 20, 2021

(54) DATA MANAGEMENT SYSTEM FOR DYNAMICALLY ALLOCATING STORAGE

(71) Applicant: Nuvoloso Inc., Sunnyvale, CA (US)

(72) Inventors: John K. Edwards, Sunnyvale, CA (US); John Joseph Glen, Sunnyvale, CA (US); Todor Ivanov Mollov, Santa Clara, CA (US)

(21) Appl. No.: 16/688,302

(22) Filed: Nov. 19, 2019

(51) Int. Cl. G06F 3/06

(52) U.S. Cl. CPC G06F 3/0647; G06F 3/0659; G06F 3/0623; G06F 3/0604; G06F 3/067

(57) ABSTRACT

A computer-implemented method comprises receiving, at a management container, an indication of a first set of service level objectives for a storage volume; based on the indication, the management container creating the storage volume, wherein the creating the storage volume includes dynamically selecting one or more storage devices from a plurality of storage devices and dynamically allocating, for each respective storage device of the one or more selected storage devices, a number of parcels at the respective storage device to use for the storage volume; in response to data being written to the storage volume, determining, by one or more service containers associated with the one or more selected storage devices, a particular parcel of the allocated parcels to write data to; and writing, by a particular service container of the one or more service containers that is associated with the particular parcel, an encrypted version of the data to the particular parcel.

### CROSS-REFERENCE TO RELATED APPLICATIONS

This application is related to U.S. patent application No. (Attorney Docket No. 60537-0013), entitled “Points in Time in a Data Management System,” wherein the entire contents of which are hereby incorporated by reference as if fully set forth herein.

### TECHNICAL FIELD

The present invention relates to storage systems and, more specifically, to cross platform data management and movement.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Most conventional solutions of solving storage issues are essentially hardware solutions. Companies build hardware devices, attach storage to them, and then provision the storage to applications. The storage may be discrete Network or Fabric attached storage systems, or may be so-called hyper-converged systems. These conventional solutions are static and inflexible in overall allocation, and require administrators and other resources to manage separate aspects of the solution.

Cloud service providers (CSPs) are third-party companies offering a cloud-based platform, infrastructure, application, and/or storage services. Users rely on the CSPs to provide storage devices. Although these cloud solutions offer more flexibility over the allocation of storage devices, users still need to manage these devices within each CSP and for multiple service level objectives (SLOs), across multiple CSPs simultaneously. For example, a user still needs to think about what type of storage to set up, what kind of backup to set up, and various security policies to put in place.

Thus, there is a need for a solution that allows data to be easily managed based on service level objectives. There is also a need for a solution that allows automated data movement based on the service level objectives.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example environment in accordance with some embodiments.

FIG. 2 illustrates an example method of storage allocation in accordance with some embodiments.

FIG. 3 illustrates an example diagram of an internal filesystem of a data storage in accordance with some embodiments.

FIG. 4 illustrates an example method of maintaining a volume and points in time of the volume in accordance with some embodiments.

FIG. 5 is a block diagram that illustrates a computer system upon which an embodiment of the disclosure may be implemented.

FIG. 6 is a block diagram of a software system that may be employed for controlling the operation of computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein provide a data management (DM) system that dynamically provisions storage devices based on broadly defined service level objectives (SLOs). In one embodiment, the SLOs that serve as the basis for storage device provisional are customer-defined. In one embodiment, the DM system automatically sets up volumes for storing data for each particular workload by selecting the right types of storage devices to achieve the SLO(s) that have been specified for that particular workload.

Specifically, the DM system manages an active filesystem that spans local and remote storage devices across one or more cloud service providers (CSPs). This is accomplished by defining a tree of map blocks and data blocks, where the data blocks are mapped across parcels allocated in each of the storage devices in order to match the required SLOs. A parcel is a division of a storage device. A volume map is built using the tree structure to allow for efficient traversal of the active volume while relying on points in time (PiTs) to construct on the fly differentials for failover and recovery as the data blocks are moved or remapped across the underlying storage. This allows movement of data blocks between the storage devices in the CSPs in efficient ways to meet ever changing SLOs. The DM system includes optimizations that tradeoff traversal performance on the active volume and traversal performance across the PiTs for recovery.

### System Overview

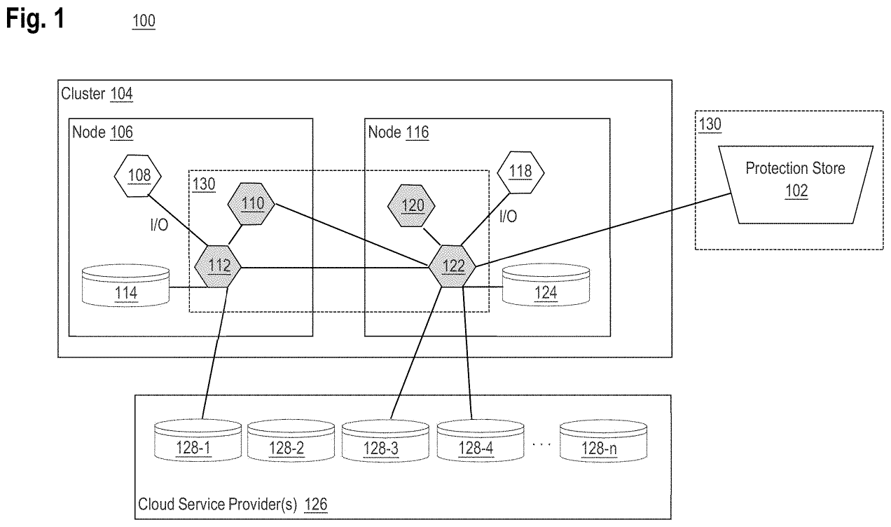

FIG. 1 illustrates an example environment in accordance with some embodiments. For simplicity and clarity of discussion, the environment 100 of FIG. 1 is illustrated to include a cluster 104 (e.g., KUBERNETES container orchestration system) running workloads within nodes 106, 116, and each of the nodes 106, 116 having a customer container 108, 118, a management container 110, 120 and a storage service container 112, 122. However, it should be noted that the environment 100 may include multiple clusters, more than two nodes in each cluster, more than one customer container, more than one management container, and/or more than one storage service container in each node. Workloads are shown as hexagons in FIG. 1. Light-colored hexagons 108, 118 are customer workloads. Dark-colored hexagons 110, 112, 120, 122 are DM system workloads.

The management containers 110, 120 together are referred herein as a management cluster. In one embodiment, the management cluster which may be separate from and outside of the cluster 104. The management cluster includes a management user interface (UI). Storage plug-ins run as a service within dedicated containers (specifically, storage service containers 112, 122) in the node 106, 116 within the cluster 104. The storage service containers 112, 122 together are referred as a storage layer. Protection store software 102 runs on the nodes 106, 116 within the cluster 104.

For purposes of simplicity, discussion herein will be in the context of a storage plug—for the KUBERNETES container orchestration system. KUBERNETES container orchestration system is an open source system for managing applications built out of multiple, largely self-contained runtimes called containers. However, in alternative embodiment, the techniques described herein may be used with other container orchestration systems and with virtual machines. The techniques are not limited to any particular type of container orchestration systems.

In an embodiment, the management cluster, the storage layer, and the protection store software together form a data management (DM) system 130. The DM system 130, as illustrated in FIG. 1, run in customer deployments. The DM system 130 provides customers, based on their defined SLOs, what looks like volumes that they can put their own filesystem in. However, underneath, the DM system 130, using techniques discussed herein, spreads that data out over various attached local and remote storage devices 114, 124, 128 obtained from one or more cloud service providers (CSPs) 126.

In an embodiment, the management cluster obtains the storage devices 114, 124, 128 from the CSP 126, attaches at least some of the network storage devices 114, 124, 128 to the storage layer, and directs the storage layer, via a communication interface, to use those storage devices to create volumes and to share them with other storage layers in the cluster 104. Some attached storage devices are local storage devices 114, 124 (within a node 106, 116), while other attached storage devices are network or remote storage devices 128-1, 128-2, 128-3, 128-4, . . . 128-n (collectively, 128). The storage devices 114, 124, 128 are of various types. Some of the storage devices 114, 124, 128 may be faster performing than other storage devices 114, 124, 128. Example storage devices include magnetic storage devices, optical storage devices, flash memory, and the like. In an embodiment, the local storage devices 114, 124 are ephemeral devices.

Customer workloads direct IOs to the storage layer, which satisfies those requests using its own local storage device 114, 124 or proxying to the network storage devices 128 either directly or indirectly via another node 106, 116. Periodically, frozen “points in time” (PiTs), which are local snapshots of a volume, may be created and transferred to a protection store 102 to become fully functioning snapshots.

The management cluster comprises a set of databases and interacts with the container orchestration system (such as KUBERNETES) via APIs and with users via APIs and a GUI.

The management cluster responds to storage requests from the container orchestration system. Container orchestration system requests may include, but are not limited to:
Creating a volume and attaching it to a container on a node;
Attaching or detaching an existing volume to or from a container; and
Destroying a volume.

The management cluster responds to requests from a user, such as an administrator. User requests may include, but are not limited to:
Initializing a volume from an image stored in a protection store (for example, cloning or restoring from a protection store image after a mishap);
Reporting SLO compliance;
Changing SLO for a volume; and
Destroying a volume.
   In an embodiment, the container orchestration system requests and the user requests may overlap or be the same and may be from the container orchestration system and/or user.

The management cluster conducts a large number of operations in order to monitor and measure SLO compliance. Example operations include:
Gathering statistics from volumes, including, but not limited to IOPS (input/output operations per second), latencies, etc., which will allow the DM system 130 to determine if the workload complies with the SLO or not; and, if not, why. Common reasons may be a failure of an underlying storage device, failure of an underlying storage device to meet the CSP's SLO, software problems within the DM system 130, and the application within the container deviating from its requested IO rates or types.
Obtaining or freeing CSP storage resources (e.g. new storage devices or different kinds of storage devices 128) as required. This will minimize obtained storage within the CSP.
Attaching CSP storage devices to nodes within the cluster, and delegating their use to a local storage service container 112, 122.
Notifying each storage service container 112, 122 of the location (IP address) of other storage service containers 112, 122 and notifying nodes of which node a particular CSP volume is attached to. This information is updated as needed.
Creating volumes and allocating parcels (e.g., divisions of storage devices) to a volume as part of changing the SLO of the volume. This also includes the reverse: deleting volumes and freeing underlying storage.
Initiating snapshots, for example starting replication of a frozen point in time (PiT) on the volume to the protection store.
Deleting snapshots from the protection store.

### Storage Allocation

A customer interacts with a container orchestration system, such as KUBERNETES, and provides a first set of SLOs for a volume. An example SLO is performing 10000 TOPS across a terabyte of data. The container orchestration system, in turn, interacts with the DM system 130, specifically a control layer, which is referred above as the management cluster. The control layer, based on the first set of SLOs, selects appropriate storage devices 114, 124, 128 obtained from one or more CSPs 126 and attaches the storage devices 114, 124, 128 to the node 106, 116 within the cluster 104. The node that a network device is attached to is that network device's local node. The storage layer in the local node is referred to as the local storage layer or as the local plug-in. The control layer notifies each local storage layer the storage device(s) that are attached to it and that it should format its attached storage device(s), which are identified with universally unique identifiers (UUIDs).

For example, referring to FIG. 1, when the first set of SLOs is received by the control layer, the control layer selects network storage devices 128-1, 128-3, and 128-4 obtained from the CSP 126 to create a volume on. The network storage device 128-1 is attached to the node 106 within the cluster 104, and the storage devices 128-4 and 128-3 are attached to the node 116 within the cluster 104. The storage service container 112 is local to the node 106 to which the storage device 128-1 is attached to; and, the storage service container 122 is local to the node 116 to which the storage device 128-3 and 128-4 are attached to. The control layer notifies each local storage layer that it has direct access to its attached storage devices and informs each local storage layer the location of other local storage layers (such as IP addresses of storage service containers 112, 122) of the nodes 106, 116 that the network storage devices 128-1, 128-3, and 128-4 are attached to.

The control layer also informs each local storage layer to format its attached storage devices. In an embodiment, formatting each of attached storage device includes creating a storage device header and dividing the storage device into parcels. Parcels are divisions of a storage device. Each parcel belongs to a single storage device. In an embodiment, a parcel may be from 256 MB to 16 GB in size. The parcels may be equally sized within each storage device. Each storage device may have its own parcel size. The parcels are dynamically allocated to one or more volumes. A parcel does not need to reside on the same node as a volume is exported on. As described elsewhere herein, a parcel is divided into segments for use by the log-based filesystem.

The storage device header in a formatted storage device includes a storage device UUID and a Device Parcel Table. The Device Parcel Table includes one or more records. Each of the records in the Device Parcel Table associates a volume UUID of a volume owning a parcel on that storage device with a parcel UUID of the parcel that the volume owns and with a parcel offset.

The control layer dynamically decides, for the volume, a target number of parcels to use for each attached storage device. For each particular attached storage device, the control layer will instruct its local storage plug-in that it is allowed to allocate, for the volume, a target number of parcels on that particular storage device. The target number of parcels may be initially decided at the time the volume is created and may change over time to allow using more parcels or to indicate that the volume should reduce its usage on the attached storage device 128-1, 128-3, and 128-4. Continuing with the example, the control layer may decide that two parcels on the storage device 128-1, two parcels on the storage device 128-3, and two parcels on the storage device 128-4 are to be used for the volume. After creating the volume, the control layer may allow the volume to use additional parcels. The additional parcels may be on the same storage device as the root parcel is on or may be on any other storage devices that the root parcel is not on. In an embodiment, while the control layer determines which storage devices 128 and how many parcels to use for the volume and the storage layer determines how the parcels will be allocated and where to put customer data.

When the control layer creates the volume, the control layer sends a create command to the local storage plug-in in the node that is associated with where the volume will be used. The create command includes information necessary to create the volume. The information necessary to create the volume includes a volume UUID of the volume, a size of the volume to be exported, a storage device UUID for the network storage device a root parcel will be created on, and a root parcel UUID of the root parcel. Some or all of the information may be duplicated for a mirrored root parcel.

The root parcel is typically created on a storage device attached to the local node that is associated with where the volume will be used, although the root parcel may be created on a remote storage device or on a storage device attached to a different node, such as a non-local node. For example, if access to a network storage device attached to a non-local node is faster, even across the network, than a network storage device that is attached to the local node, then the root parcel may be created on the network storage device attached to a non-local node. Continuing with the example, assume the local node associated with where the volume will be used is the node 106. The local storage service container would be the storage service container 112. The root parcel may be created in the network storage device 128-1 that is attached to the local node 106. In an embodiment, when more than one network storage device is attached to the local node 106, then one of them is selected by the control layer, either randomly or based on a plurality of factors, to create the root parcel on.

The root parcel stores a manifest. The manifest includes a plurality of tables, such as a Device Table and a Parcel Table, which are distinct from the Device Parcel Table described above. The manifest also stores other information such as root records associated with the volume. The root records include identifying information for the active volume and for any PiTs of the volume. The root records are discussed elsewhere herein.

In an embodiment, the Device Table for the volume includes a device entry for each storage device the volume uses. The device entry may include a storage device UUID of a corresponding storage device the volume uses. In an embodiment, a runtime table, not on storage, includes information regarding the node to which a storage device is attached to, the class or type of the storage device (such as elastic block store), the target number of parcels on the storage device, and the size of each parcel on the storage device. Continuing with the example, the Device Table includes device entries describing the storage device UUIDs of storage device 128-1, 128-3, and 128-4 that are used by the volume. Using stored storage device UUID in the Device Table and mappings (e.g., storage device UUID to node UUID, and node UUID to IP address) in the runtime table, the storage layer knows where and how to communicate with any of the storage devices 128-1, 128-3, and 128-4 for the volume.

As space is needed for the volume, the local node may communicate with the node that one of the storage devices is attached to (which may be itself or another node), to allocate a parcel from that storage device to the volume, and record that parcel, identified by its parcel UUID, in the Parcel Table. In an embodiment, the Parcel Table for the volume includes a parcel entry for each parcel allocated for the volume. The parcel entry may include information regarding the storage device (e.g., storage device UUID) to which a parcel is allocated on. Continuing with the example, the Parcel Table includes entries describing that the two parcels, Parcel A and Parcel B, are on the storage device 128-1, that the two parcels, Parcel C and Parcel D are on the storage device 128-3, and that the two parcels, Parcel E and Parcel F, are on the storage device 128-4. In an embodiment, only the local node (e.g., the node managing the storage device) knows the actual location of the allocated parcel via the Device Parcel Table.

In an embodiment, the Device Table and the Parcel Table are implemented as a two-stage intent/commit log to avoid leaking space when allocating or freeing parcels.

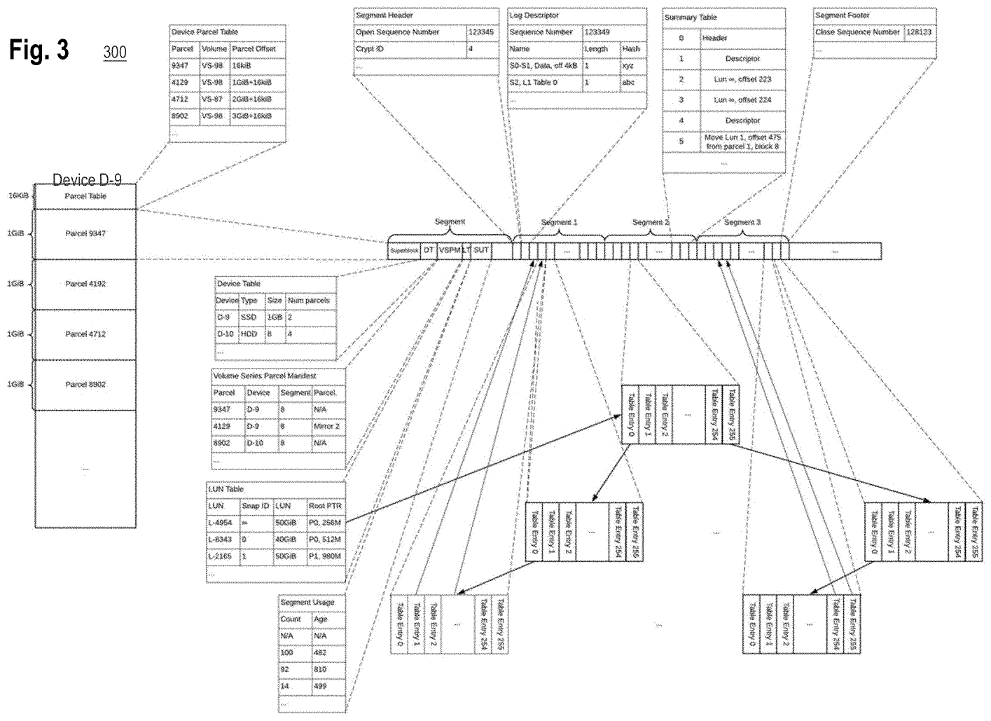

It should be noted that the tables, such as the Device Table and the Parcel Table, have been described as separate tables but can be combined into one or divided into smaller tables. The Parcel Table is referred to as the Volume Series Parcel Manifest and the Device Table is referred to as the Device Table in FIG. 3. It should be noted that each node, each volume, each storage device, and each root parcel is associated with a UUID and is referred to within the DM system 130 and in all tables by its UUID.

In an embodiment, all information in the root parcel is also stored in the set of databases associated with the control layer. In an embodiment, only the manifest in the root parcel is stored in the set of databases associated with the control layer.

The control layer and the storage plug-in may mix parcels within one or more storage devices to meet the SLO of the volume. For example, the volume may be allocated parcels on fast local ephemeral devices for caching, relatively fast random access parcels for storage of metadata and hot data, and slower storage parcels for colder data. As the desired SLO of the volume is changed, target allocation of parcels can be increased or decreased on different storage devices. In addition, storage devices and parcels on the storage devices for the volume may change when work cluster nodes fail, when storage devices fail, when network problems arise, upon a DM system 130 reboot, or when offline storage devices are brought back online. The selection of storage devices and the allocation of parcels are malleable within the DM system 130.

When a customer I/O operation occurs, the DM system 130 (specifically, the storage service container 112, 122) determines which parcel and which block to read data from or to write data to. For example, the customer I/O operation may be to read data from block 23 in the volume, which the filesystem would determine is Block 5 of Parcel D. In response, it is determined, from the manifest, that Parcel D is on is on the storage device 128-3 and where that storage device 128-3 is. Data from Block 5 of Parcel D on the storage device 128-3 is read and returned to the customer.

### Data Movement

When data is written to the volume, there is a basic assumption that the system will place the data wherever it determines is best at the moment and that it will move it later when convenient. However, the data is moved based on the constraints that the control layer designated. There are multiple reasons as to why data might move.

One of the reasons relate to the internal filesystem. Briefly here and as further explained elsewhere herein, the filesystem allows data to be written in a new place every time a block with that address is written in a volume and, as free space is required to satisfy new writes, data is read from segments that are relatively empty and written to segments that are then mostly full to reuse segments.

When data is referenced, a parcel index and a block offset (for example, Block 5 of Parcel D) are provided. The parcel index may be a virtual parcel index, meaning that the data in a corresponding parcel is mirrored from one or more other physical parcels. The DM system 130 may perform procedures related to mirroring, RAID, or error correction codes for reliability. For example, customer data, from the filesystem's perspective, may be placed into a particular parcel, but in reality, it may be placed in two different parcels on two different storage devices such that if one of storage devices goes away, the customer data is not lost. When one storage device goes away, the DM system 130 corrects the issue by picking a new parcel to mirror to and moving customer data into that new parcel. Thus, a reason why data might move is that the place that data was put has become bad for some reason (for example, half the storage devices went away, or an entire node went away). The DM system 130 self-heals, without disrupting the customer, to preserve customer data.

Another reason as to why data might move is that the system (e.g., thru internal analysis and reflection) and/or the customer may decide that they have made a wrong decision regarding the first set of SLOs and would really rather have a different set of SLOs. The customer sends a request to the control layer with a second set of SLOs for their volume. In response to the second set of SLOs, the control layer may select a different set or different mix of storage devices, which may include faster or slower storage devices, storage devices of different parcel sizes, etc. For example, instead of selecting storage device 128-3 and 128-4, the control layer may keep the originally selected storage device 128-1 and may select new storage device 128-2 and allocate three parcels on that storage device 128-2. Parcels C and D on the storage device 128-3 and the Parcels E and F on the storage device 128-4 would be freed up after the data are written therefrom to the newly selected storage device 128-2. In an embodiment, if storage devices 128-3 and 128-4 are no longer used, these storage devices 128-3 and 128-4 may be returned to the CSP 126.

The customer may still later decide that the second set of SLOs was a mistake and want to go back to the first set of SLOs. In response, the control layer may select the storage devices 128-3 and 128-4 (or other storage devices), rather than the storage device 128-2, and reallocate two parcels at each of the storage devices 128-3 and 128-4. The newly allocated parcels at the storage devices 128-3 and 128-4 may be or may not be the same as the previously allocated parcels at the storage device 128-3 and 128-4. It is possible that the control layer allocates a different target number of parcels than before at each of the storage devices 128-3 and 128-4.

If a new customer creates a new volume, for example, on the node 116, the control layer may select storage devices 128-3 and 128-4 and allocate two parcels on each of the storage device 128-3 and 128-4, and the storage layer may select previously released and currently available parcels that were used by another customer.

The local storage devices 114, 124 may be used for caching as access to them may be faster than the network storage devices 128. In an embodiment, all data in the local storage devices 114, 124 are also stored in the network storage devices 138 such that if the local storage devices 114, 124 become nonoperational, the data are still in the slower, more reliable storage devices 128.

### Performance Statistics

In an embodiment, the storage layer continuously monitors performance of its attached storage devices, such as how long it takes to complete an I/O. Data from the monitoring is collected or otherwise received by the control layer and statistics on the data are obtained and stored in a database. Based on the data, the control layer conducts a plurality of operations to ensure compliance of the SLOs. Example operations include obtaining additional storage devices, allocating new parcels, selecting new storage devices for the volume, and to stop using one or more storage devices, to ensure SLO compliance. Other operations are discussed elsewhere herein.

The control layer provides, in a GUI, statistics regarding performance of the storage devices 128 and issues with the CSP 126. In an embodiment, the GUI also displays suggestions regarding what needs to be fixed shall the customer prefer to apply fixes themselves. In an embodiment, the DM system 130 self-heals rather than requiring customer intervention to minimize failure to maintain SLO.

### Storage Allocation Example

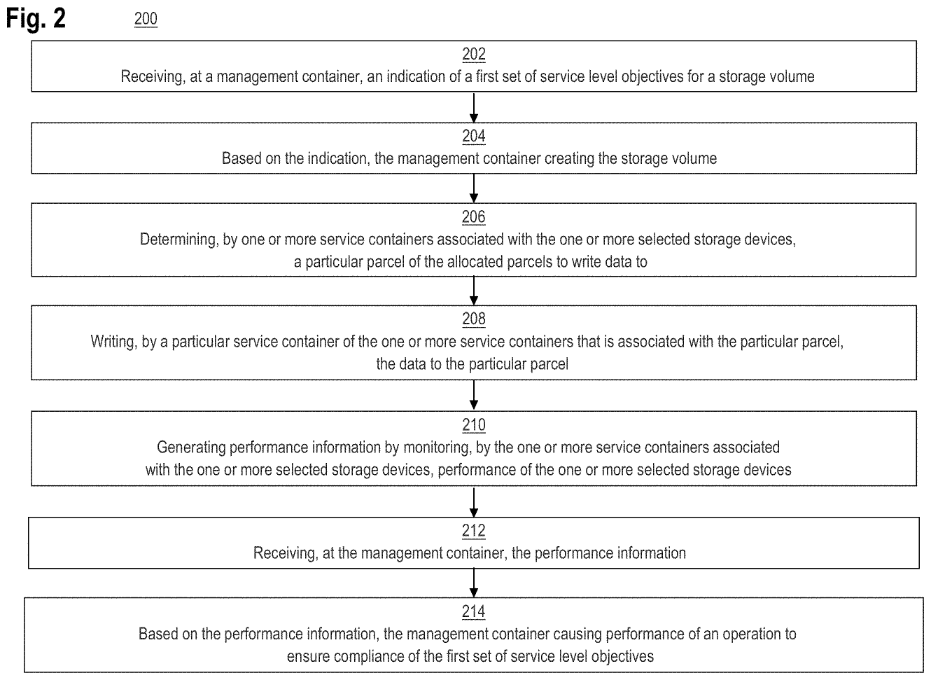

FIG. 2 illustrates an example method of storage allocation in accordance with some embodiments. Method 200 includes operations, functions, and/or actions as illustrated by steps 202-214. For purposes of illustrating a clear example, the method of FIG. 2 is described herein with reference to execution using certain elements of FIG. 1; however, FIG. 2 may be implemented in other embodiments using computing devices, programs or other computing elements different than those of FIG. 1. Further, although the steps 202-214 are illustrated in order, the steps may also be performed in parallel, and/or in a different order than described herein. The method 200 may also include additional or fewer steps, as needed or desired. For example, the steps 202-214 can be combined into fewer steps, divided into additional steps, and/or removed based upon a desired implementation. FIG. 2 may be used as a basis to code method 200 as one or more computer programs or other software elements organized as sequences of instructions stored on computer-readable storage media. In addition, one or more of steps 202-214 may represent circuitry that is configured to perform the logical functions and operations of method 200.

At step 202, an indication of a first set of service level objectives for a storage volume is received at a management container.

Based on the indication, at step 204, the storage volume is created by the management container. The storage volume is exported on a node in a cluster. The cluster may include one or more nodes, including the node that the storage volume is exported on. Each of the one or more node includes a management container and a service container.

Based on the indication, the management container dynamically selects one or more storage devices from a plurality of storage devices that is obtained from one or more storage systems. In an embodiment, the management container may first determine whether to obtain new storage device(s) from a CSP(s). Only once the management container is sure it has enough storage, it selects the one or more storage devices for the volume.

The plurality of storage devices may include storage devices of different types. Each of the plurality of storage devices is divided into a plurality of parcels. The parcels may be equally sized within each storage device. Each storage device may have its own parcel size. The parcels are dynamically allocated to one or more storage volumes.

Each of the one or more selected storage devices is attached, if not already, to one of the one or more nodes that are associated with the storage volume. The management container notifies each service container in the one or more nodes that are associated with the storage volume, location information (such as IP address) of other service containers in the one or more nodes associated with the storage volume. The management container also indicates to each service container in each node associated with the storage volume to format each storage device attached to the node that the service container is in.

The service container transmits a create signal to the service container in the node that the storage volume is to be exported on. A root parcel is created on a storage device, selected by the service container, that is to be the target storage device, which may or may not be local to the node, in response to the create signal. The root parcel includes a manifest and root records associated with the storage volume.

Based on the indication, the management container dynamically determines, for each respective storage device of the one or more selected storage devices, a number of parcels at the respective storage device to use for the storage volume.

In response to data being written to the storage volume, at step 206, a particular service container from the one or more service containers associated with the one or more selected storage devices allocate a particular parcel of the selected parcels to write data to. At step 208, a particular service container of the one or more service containers that is associated with the particular parcel, writes the data to the particular parcel.

At step 210, performance information is generated by monitoring, by the one or more service containers associated with the one or more selected storage devices, performance of the one or more selected storage devices.

At step 212, the performance information is received at the management container.

At step 214, based on the performance information, the management container causes performance of an operation to ensure compliance of the first set of service level objectives (SLOs). An example operation is selecting new storage devices for the storage volume, allocating new parcels, or stopping use of one of the one or more selected storage devices, to ensure compliance of the first set of SLOs. When an indication of a second set of SLOs for the storage volume is received at the management container, the management container will also cause performance of an operation to ensure compliance of the second set of SLOs.

### Encryption

In accordance with the specified SLO, the data may be encrypted. In an embodiment the data may be encrypted using mechanisms provided by the CSP through underlying storage devices. In an alternative embodiment, the data may be encrypted by the filesystem. Encryption keys may be provided to the running system at the time a volume is brought online on a data processing node.

### Protection Store

In an embodiment, the local storage plug-in presents a volume interface to the application in a customer container. This can be presented in a number of ways. In an implementation, the active volume is exported to the users as a file in a Filesystem in Userspace (FUSE) filesystem in LINUX. In another implementation, the active volume is exported to the users as a block device (via a network block device) or as an iSCSI device or the like. The customer container may use the volume as the block device or use the contained filesystem within the device. Over time, the DM system 130 creates local points in time (PiTs) of the active volume to be used to create snapshots in the protection store 102. In an embodiment, the creation of PiTs and replication to create snapshots are driven by the management cluster to satisfy a data protection portion of a SLO.

In an embodiment, the control layer tells the application to quiesce, to ensure a consistent image or PiT, to subsequently create a snapshot. This can include quiescing a multi-container workload to get a consistent set of PiTs across a collection of volumes. A data management software may be used to read the PiT to send data associated the PiT to the protection store to create a snapshot. For example, differences between the PiT and a previous PiT may be generated and transferred to a protection store to create a new snapshot based on a previous snapshot corresponding to the previous PiT. PiTs are staging grounds for generating usable snapshots in the protection store.

An example protection store and an example method of creating snapshots are described in copending U.S. application Ser. No. 16/660,737, entitled “Data Movement between Heterogeneous Storage Devices,” copending U.S. application Ser. No. 16/660,741, entitled “Data Structure of a Protection Store for Storing Snapshots,” and U.S. application Ser. No. 16/660,750, entitled “Garbage Collection of Unreferenced Data Objects in a Protection Store,” wherein the entire contents of which are hereby incorporated by reference as if fully set forth herein.

### Internal Filesystem

Customer IOs to a volume are translated, by the filesystem within the storage service container (e.g. 112), to IOs to an underlying storage that has been made available to the volume by the control layer. In an embodiment, the translation is accomplished via a logging file/storage system.

The active volume and each PiT are each internally represented within the filesystem in 112 as a tree of blocks. The tree representative of the active volume is referred to as a volume tree, and the tree representative of a PiT is referred to as a PiT tree. The blocks in a tree include map blocks and data blocks. Map blocks store system data that informs the filesystem within 112 where further data is as opposed to a data block that stores customer data. Map blocks are also referred to as maps. Data blocks in a tree are leaves. Each tree includes a root block, which is the topmost block in the tree.

Each non-root block is referenced via a map entry for that data or the subtree below it. The map entry may contain a media address or a constant value, as well as information relating the tree to other trees within the filesystem. A media address includes a parcel index, which is an index of a parcel in the Parcel Table of the manifest, and a block offset within the parcel. The media pointer also includes a hash value of the block it is pointed at such that if a wrong data is read, it would result in a hash mismatch and no data would be returned. A constant value in the map entry means that the data below in the map tree is filled with the same 64 byte word, and no actual blocks are used to store that data. An example situation is when the filesystem within 112 is created and an entire volume is filled with zero's, in which case, the volume tree would not be filled with media addresses and would instead include a single constant value zero pointers; any read operation would return a zero. As (non-constant) data is written to the system the portions of the tree containing that data will be populated with media addresses. The media pointer may also include other information and flags, such as the type and flag bits used to associate corresponding blocks between PiT trees and the volume tree as described below.

When a media address contains a media entry, the Parcel Table translates a parcel index into a device UUID and parcel UUID, allowing a read or write operation to be forwarded, if necessary, to the storage plug-in on another node (e.g. 122).

In an embodiment, each map block includes 256 map entries, each map entry addressing a 4 KB block. Thus, one level of map blocks addresses 1 MB of data blocks (256*4 KB), two levels of map blocks address 256 MB of data blocks, three levels of map blocks address 64 GB of data blocks, etc.

In an embodiment, the root block of the volume tree and the root blocks of each PiT are stored in a LUN Table in the manifest. A reading of a given data block within the filesystem in 112 requires reading this top-level block from the LUN Table (and verifying the hash), and then using a map entry within that block to read another block, and then another, and so on, traversing down the volume tree to get to the bottom of the volume tree. For efficiency, the filesystem in 112 may maintain a cache of these map blocks in memory such that the next traversal of the volume tree is faster than the first traversal. The one or more map blocks may be cached, alternatively, in any of the storage devices 114, 124, 128, depending on which one would be faster to retrieve data from. At the bottom of the volume tree are data blocks.

As described herein, each parcel in a storage device is divided into segments. The segments within a parcel will be equally sized, such as four megabytes but different parcels may contain different sized segments. Typically, each parcel in a storage device has an equal number of segments, but ultimately the filesystem may choose to use different segment sizes in different parcels based as is most efficient. A parcel includes an integral number of segments. In an embodiment, a segment within a parcel is between 256 KB and 64 MB in size. In an embodiment, a segment within a parcel is 4 MB in size. The filesystem uses a small number of the segments either to hold the manifest and the vast majority to hold log segments within the filesystem.

Each log segment includes a segment header, a summary table and a segment footer, in addition to log entries. Every log segment has a log number to order log segments and to access a particular log segment. Similarly, every log entry has a sequence number to order log entries and to access a particular log entry. The segment header identifies the segment and is written when a segment is first opened to accept log entries. The footer marks that a segment is fully completed and will not be written to again, until that segment is emptied and reused for a later segment in the log. The Summary Table contains a small entry for each block within the segment and allows replaying of metadata within the log without reading the entire log.

Changes to the state of the active volume and PiTs, via writes of data, creation and deletion of PiTs, are recorded as they happen in log segments. Multiple log segments may be opened on multiple storage devices at any time to allow parallelism as well as to allow placement of different classes of data onto different storage devices. Parallelism enables load balancing and performance management of the filesystem in 112. Opened log segments may be for the same volume or for different volumes. At any particular point in time, the filesystem in 112 may be logging data to one of the opened log segments.

When writing customer data or maps (higher level blocks or non-leave blocks in the volume tree), a number of blocks (in an embodiment, 1-256 blocks) and a descriptor describing the data (such as a location within the tree) are written as log entries in a segment log. The descriptor may include other information. For example, when a customer writes data, such as 16 kilobytes of data at offset X, the filesystem in 112 determines a location in the storage devices to write the data and records, in a corresponding log segment, a descriptor, which indicates that four blocks at offset X is written, and the four blocks of data. When the next write comes in, the write is recorded in the log segment, with a descriptor indicating that six blocks at offset Y is written, and the six blocks of data.

Log entries may also record creation or deletion of PiTs as well as one or more forks in the log segment. A fork indicates an additional log segment in the volume. A segment may contain no forks, indicating that that branch of the log ends, or forks to one or more other segments that continue the log.

When a log segment is filled, the Summary Table within the log segment is written within the segment and the log segment is closed. The Summary Table includes information from the descriptors of the closed log segment. The Summary Table allows for rapid log replay (fewer blocks to read) and to rapidly find which blocks are still in use within a log segment when log segments are cleaned for reuse. As the segment is closed, the sequence number of the segment is recorded in the manifest to allow the filesystem to know the segment is in use and to provide a rough estimate of the age of the segment to drive later cleaning and data movement.

To reduce the time and to increase efficiency in rebuilding the map, the DM system 130 periodically executes a checkpoint. A checkpoint ensures that all changes to higher level maps are committed to log and rolled up into the top of the volume tree (and stored as in the root record in the LUN Table). This allows the filesystem to begin the log replay at a sequence number that is recorded in the manifest along with the set of segments which contain the current start of the log. In other words, the log entries before the check point do not need to be replayed because they are recorded in the root block of the volume tree. Each log segment, when used, is given a monotonically increasing age, which allows the filesystem to determine which log segments are no longer needed for log replay but are only useful for the data they still contain.

When the state of the filesystem is reconstructed, for example, after a reboot, the filesystem finds the root record of the volume tree to the LUN Table and finds the log segments that were written to before the reboot or crash, to replay the changes, one by one, to rebuild the map. For closed segments the replay process can use the Summary Table of the segment to “know” how blocks within it were used when written. For the segments at the “end” of the log, the replay process must read the entire segment, including data that has not yet been written to. It can then identify pertinent log entries via the descriptors within the log segment. In either case, the relevant operation such as a write of data, moving of data or snapshot operations may be replayed.

In an embodiment, a parcel may be broken into 256 segments with corresponding segment counters. A segment can be cleaned by removing whatever data is in that segment out to somewhere else so that the segment can be reused for new logging over time. Another reason to clean a segment is to move the data to a new location so as to move all data off of a parcel such as when changing SLOs. If parcels are mirrored or striped for reliability, a degraded parcel may be recovered by cleaning all segments within the parcel to new locations.

In an embodiment, the cleaning process is guided by keeping track of the number of blocks are used within a segment along with the relative age to allow the most advantageous segments. This information may be stored in a Segment Usage Table in the manifest.

When a segment is being cleaned, data in the segment is checked to see if it is still being used by consulting the volume tree and PiT trees. If not, then the data can be written out somewhere else, such as another log segment. When the segment is being cleaned, data in the segment before a checkpoint may also be written out to another log segment. These “garbage collection” segment entries include information in the descriptor indicating where the blocks were moved from. This allows the system to detect cases in which data has fallen out of use after the moving process has begun, which results in the newly moved data being immediately freed as “unused”. As soon as all of the blocks in a segment are either no longer used, either by naturally falling out of use or by having been moved, then the segment will become available and free for reuse after the next consistency point. It is necessary to wait for the next consistency point to ensure that no blocks in that segment will be encountered in the volume or PiT trees during a replay.

### Filesystem Example

FIG. 3 illustrates an example diagram of an internal filesystem of a data storage in accordance with some embodiments. The diagram 300 shows an internal filesystem of data storage Device D-9. Device D-9 may be a storage device attached to a node that is associated with where a volume is used or exported. Device D-9 includes a storage device header, which 16 KB in size. The storage device header (labeled in FIG. 3 as Parcel Table) stores a Device Parcel Table.

Device D-9 is divided into numerous parcels, each having 1 GB in size. Each parcel is divided into numerous segments. The first parcel, Parcel 9347, is the root parcel for the volume. The first segment, labeled as Segment 0, of the root parcel includes a Volume Series Parcel Manifest, a LUN Table, and a Segment Usage Table. Segment 0 also stores other tables, such as a Summary Table, not illustrated in FIG. 3. Changes to the volume are stored in segments in parcels associated with the volume. Each segment includes a segment header and a segment footer. Changes to the volume are written to a segment between the segment header and the segment footer, and each log entry includes a log descriptor followed by data to be written.

### Points in Time

In one embodiment, points in time are implemented as separate trees of data. A map entry in a PiT tree may be marked as “shared” instead of an actual pointer to a data block. This indicates that a read for the PiT tree should instead be read from the next youngest PiT tree (and so on, eventually to the active volume tree). It is an implicit sharing of a data block. Conversely, a more recent PiT tree may mark a map entry as COW (copy on write). The purpose of a COW is to ensure that, when a data block is overwritten or deleted in the active volume, the map entry is moved to the corresponding location in the next oldest PiT tree instead of simply freed since the data block is still being used by that next oldest PiT tree. In an embodiment, one or more bits in each map entry are used to indicate a share or a COW.

The filesystem supports numerous PiT trees, each identified with a time-based PiT identifier, which may be used indicate the age of a corresponding PiT tree. The DM system 130 supports 256 PiT trees but may support more or less PiT trees, but is optimized for a relatively small number of PiTs, since the Data Management system will provide store the bulk of snapshots in an external Protection Store. In an embodiment, the root block of each PiT tree is also stored as a root record in the LUN Table in the manifest. Incremental changes between two PiT trees may be determined and sent to the protection store to create a snapshot. The two PiT trees differenced in this manner may not necessarily be consecutive PiT trees. The two PiT trees may be separated by one or more other PiT trees. The use of shared and COW indicators enables easy traversal of the trees to find differences in data. This allows the system to only read actual data that does need to be transversed.

When changes, such as data writes, in the active volume are made, data blocks, corresponding to the changes, that the volume tree references, are moved to the youngest PiT tree in the DM system 130 such the youngest PiT tree references by media pointers to the corresponding data blocks. Corresponding map entries in the youngest PiT tree are set to COW. This only involves moving the media pointers to the data between trees and does not require the actual moving of the data.

Common techniques for snapshots include copying snapshotted data out to new locations as changes are made to the active copy, sharing blocks between active and snapshot trees, and leaving data in snapshots and only applying new data to a sparse active tree. In contrast to these techniques, the PiT tree is sparse and only contains data that has been overwritten in the active copy. Every pointer to a data block only appears once in this set of trees, including the volume tree and PiT trees. The present technique described herein keeps traversal minimal while working in the active filesystem because the active filesystem is where customers are working, at the cost of more traversals in the PiT trees. It also minimizes the accounting processing required in sharing blocks between trees and the costs of copying data in a copy-out scheme.

PiTs are created under the control of the control layer. In an embodiment, PiTs are created periodically, such as hourly, daily, or some other interval. When a new PiT is created, the control layer pauses customer IOs for an instant (less than a second, usually in milliseconds) to create a new PiT tree that is parallel with the active volume tree. At this time, the new PiT tree is an empty hierarchy with map entries set to shared. However, as changes start to occur in the active volume, the PiT tree will start populating as described above in response to overwrites in the active volume. In an embodiment, the control layer may simultaneously pause multiple volumes on multiple nodes to create a consistent PiT across a group of volumes. It may further coordinate with contained applications to provide application consistent PiTs and snapshots.

When a PiT is deleted, all the data blocks that the corresponding PiT tree owns or references, that its neighboring PiT tree older than it is relying on, are moved to the neighboring older PiT tree such that the neighboring older PiT tree references by media points to those data blocks. Corresponding map entries in the neighboring older PiT are set to COW. As with any freed block, the appropriate segment counter(s) is decremented since a block(s) corresponding log segments are now free. As discussed herein, the segment counter is used to determine which locations to clean. Any PiT, not necessarily the youngest one or the oldest one, may be deleted from the DM system 130.

### Example of Maintaining Points in Time

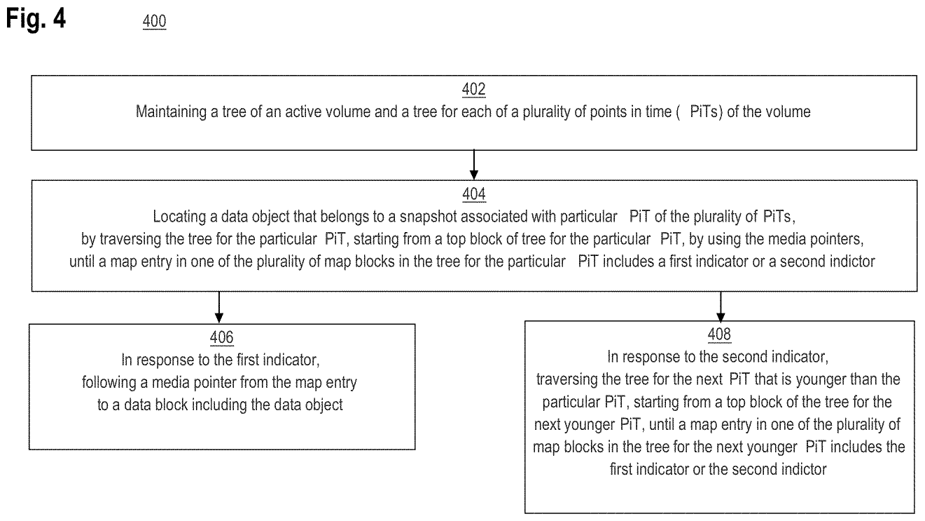

FIG. 4 illustrates an example method of maintaining a volume and points in time of the volume in accordance with some embodiments. Method 400 includes operations, functions, and/or actions as illustrated by steps 402-406. For purposes of illustrating a clear example, the method of FIG. 4 is described herein with reference to execution using certain elements of FIG. 1; however, FIG. 4 may be implemented in other embodiments using computing devices, programs or other computing elements different than those of FIG. 1. Further, although the steps 402-406 are illustrated in order, the steps may also be performed in parallel, and/or in a different order than described herein. The method 400 may also include additional or fewer steps, as needed or desired. For example, the steps 402-406 can be combined into fewer steps, divided into additional steps, and/or removed based upon a desired implementation. FIG. 4 may be used as a basis to code method 400 as one or more computer programs or other software elements organized as sequences of instructions stored on computer-readable storage media. In addition, one or more of steps 402-406 may represent circuitry that is configured to perform the logical functions and operations of method 400.

At step 402, a tree of an active volume and a tree for each of a plurality of points in time (PiTs) of the volume are maintained. The tree for each of the PiT of the volume is separate from but parallel with the tree of the active volume. Each of the trees includes a plurality of map blocks and a plurality of data blocks. Each map block references other blocks by media pointer. Each of the plurality of map blocks contains system data, while each of the data blocks contains customer data.

At step 404, a data object that belongs to a snapshot associated with particular PiT of the plurality of PiTs is located. The step 404 may include traversing the tree for the particular PiT, starting from a top block of tree for the particular PiT, by using the media pointers. The traversal of the tree stops until a map entry in one of the plurality of map blocks in the tree for the particular PiT includes a first indicator or a second indictor. The first indicator indicates that the data object is located. The second indictor indicates an implicit sharing of the data object.

In response to the first indicator, at step 406, a media pointer from the map entry is followed to a data block that includes the data object.

In response to the second indicator, at step 408, the tree for the next PiT that is younger than the particular PiT is traversed, starting from a top block of the tree for the next younger PiT, until a map entry in one of the plurality of map blocks in the tree for the next younger PiT includes the first indicator or the second indictor. If the data object has not yet been located, the step 406 continuously repeats with a tree for another younger PiT until the tree for the active volume is reached.

In an embodiment, root blocks of the trees are stored as root records in a manifest that is stored in a storage device of a plurality of storage devices selected to create the volume on. In an embodiment, log segments for the volume are also stored in the manifest. Changes to the active volume and creation and deletion of PiTs are logged in the log segments.

When a change is made to the active volume, a data block, corresponding to the change, that the tree of the active volume references, is moved to the tree for the youngest PiT from the plurality of PiTs such that the tree for the youngest PiT references by a media pointer to the data block including the data object. A corresponding map entry in the tree for the youngest PiT is set to the first indicator.

A new PiT may be created by pausing customer IOs. A new PiT tree for the new PiT is built. The new PiT tree starts off as an empty hierarchy with map entries set to shared.

A selected PiT from the plurality of PiTs may be deleted. Data blocks that the tree for the selected PiT references, are moved to the tree for a neighboring PiT that is older than the selected PiT such that the tree for the neighboring PiT references by media pointers to the data blocks. Corresponding map entries in the tree for the neighboring PiT are set to the first indicator.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

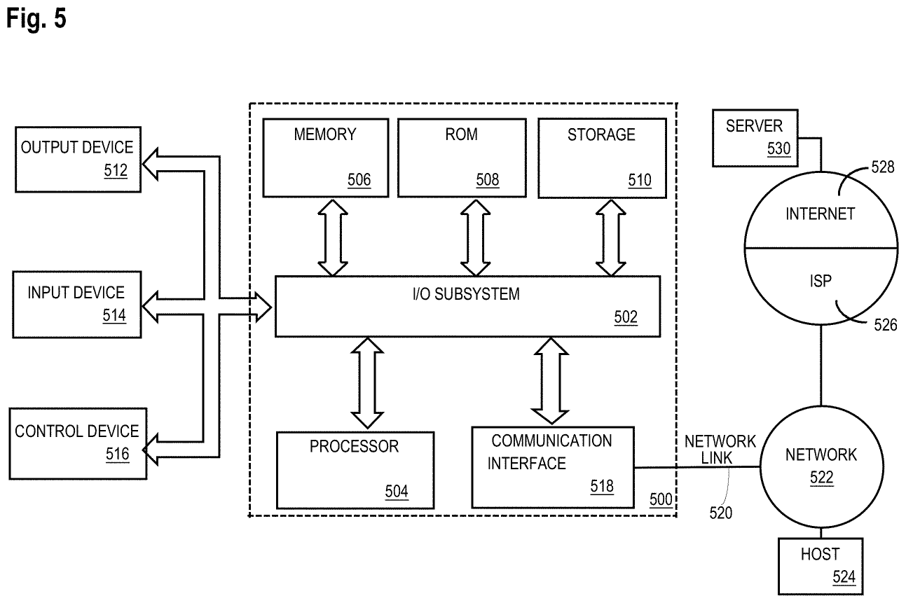

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

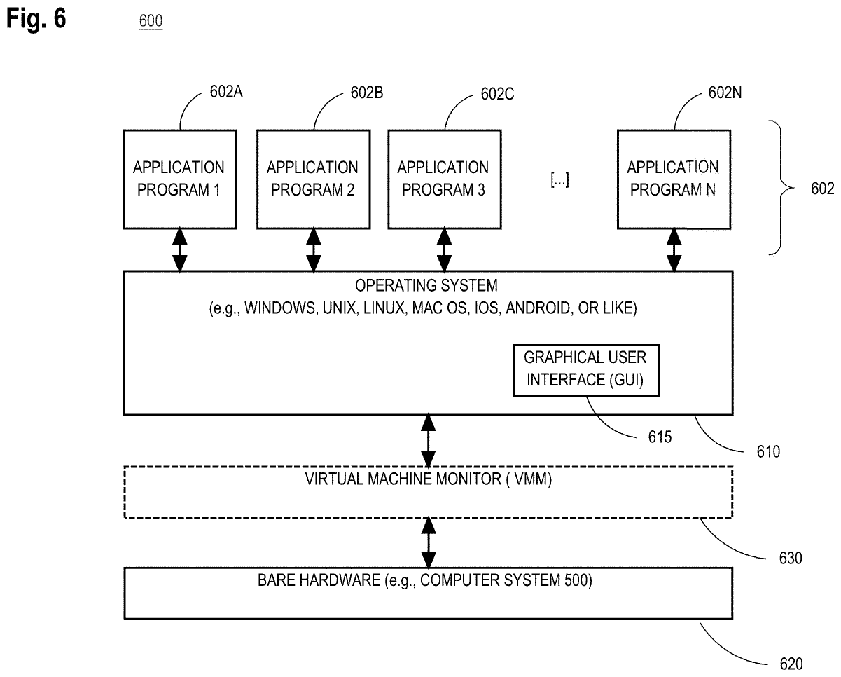

FIG. 6 is a block diagram of a software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 410 into memory 406) for execution by the system 400. The applications or other software intended for use on system 400 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of system 600. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### OTHER ASPECTS OF DISCLOSURE

In the foregoing specification, embodiments of the invention have been described with reference to numerous specific details that may vary from implementation to implementation. Thus, the sole and exclusive indicator of what is the invention and, is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including,” “includes,” “comprising,” “comprises,” “comprised” and the like) are intended to be inclusive and are not intended to exclude further features, components, integers or steps.

Various operations have been described using flowcharts. In certain cases, the functionality/processing of a given flowchart step may be performed in different ways to that described and/or by different systems or system modules. Furthermore, in some cases a given operation depicted by a flowchart may be divided into multiple operations and/or multiple flowchart operations may be combined into a single operation. Furthermore, in certain cases the order of operations as depicted in a flowchart and described may be able to be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

What is claimed is:

1. A computer-implemented method comprising:
receiving, at a management container, an indication of a first set of service level objectives for a storage volume;
based on the indication, the management container creating the storage volume, wherein the creating the storage volume includes:
based on the indication, dynamically selecting one or more storage devices from a plurality of storage devices from one or more storage systems, wherein the plurality of storage devices includes storage devices of different types, wherein each of the plurality of storage devices is divided into a plurality of parcels;
based on the indication, dynamically allocating, for each respective storage device of the one or more selected storage devices, a number of parcels at the respective storage device to use for the storage volume;
in response to data being written to the storage volume:
determining, by one or more service containers associated with the one or more selected storage devices, a particular parcel of the allocated parcels to write data to;
writing, by a particular service container of the one or more service containers that is associated with the particular parcel, an encrypted version of the data to the particular parcel;
generating performance information by monitoring, by the one or more service containers associated with the one or more selected storage devices, performance of the one or more selected storage devices;
receiving, at the management container, the performance information; and
based on the performance information, the management container causing performance of an operation to ensure compliance of the first set of service level objectives.

2. The computer-implemented method of claim 1, wherein the storage volume is exported on a node in a cluster, wherein the cluster includes one or more nodes that include the node that the storage volume is exported on.

3. The computer-implemented method of claim 2, wherein the creating the storage volume further includes:
attaching each of the one or more selected storage devices to one of one or more nodes associated with the storage volume;
notifying each service container in the one or more nodes associated with the storage volume, location information of other service containers in the one or more nodes associated with the storage volume;
indicating to each service container in each node associated with the storage volume to format each storage device attached to the node that the service container is in.

4. The computer-implemented method of claim 3, wherein the creating the storage volume further includes transmitting a create signal to a service container in the node that the storage volume is exported on.

5. The computer-implemented method of claim 4, further comprising creating a root parcel on a storage device that is attached to the node in response to the create signal.

6. The computer-implemented method of claim 5, wherein the root parcel includes a volume series parcel manifest and root records associated with the storage volume.

7. The computer-implemented method of claim 1, further comprising receiving, at the management container, an indication of a second set of service level objectives for the storage volume.

8. The computer-implemented method of claim 1, wherein the operation is selecting new storage devices for the storage volume.

9. The computer-implemented method of claim 1, wherein the operation is allocating new parcels.

10. The computer-implemented method of claim 1, wherein the operation is stopping use of one of the one or more selected storage devices.

11. One or more non-transitory computer-readable storage media storing one or more sequences of program instructions which, when executed by one or more computing devices, cause:
receiving, at a management container, an indication of a first set of service level objectives for a storage volume;
based on the indication, the management container creating the storage volume, wherein the creating the storage volume includes:
based on the indication, dynamically selecting one or more storage devices from a plurality of storage devices from one or more storage systems, wherein the plurality of storage devices includes storage devices of different types, wherein each of the plurality of storage devices is divided into a plurality of parcels;
based on the indication, dynamically allocating, for each respective storage device of the one or more selected storage devices, a number of parcels at the respective storage device to use for the storage volume;
in response to data being written to the storage volume:
determining, by one or more service containers associated with the one or more selected storage devices, a particular parcel of the allocated parcels to write data to;
writing, by a particular service container of the one or more service containers that is associated with the particular parcel, an encrypted version of the data to the particular parcel;
generating performance information by monitoring, by the one or more service containers associated with the one or more selected storage devices, performance of the one or more selected storage devices;
receiving, at the management container, the performance information; and
based on the performance information, the management container causing performance of an operation to ensure compliance of the first set of service level objectives.

12. The one or more non-transitory computer-readable storage media of claim 11, wherein the storage volume is exported on a node in a cluster, wherein the cluster includes one or more nodes that include the node that the storage volume is exported on.

13. The one or more non-transitory computer-readable storage media of claim 12, wherein the creating the storage volume further includes:
attaching each of the one or more selected storage devices to one of one or more nodes associated with the storage volume;
notifying each service container in the one or more nodes associated with the storage volume, location information of other service containers in the one or more nodes associated with the storage volume;
indicating to each service container in each node associated with the storage volume to format each storage device attached to the node that the service container is in.

14. The one or more non-transitory computer-readable storage media of claim 13, wherein the creating the storage volume further includes transmitting a create signal to a service container in the node that the storage volume is exported on.

15. The one or more non-transitory computer-readable storage media of claim 14, wherein the one or more sequences of the program instructions which, when executed by the one or more computing devices, further cause creating a root parcel on a storage device that is attached to the node in response to the create signal.

16. The one or more non-transitory computer-readable storage media of claim 15, wherein the root parcel includes a volume series parcel manifest and root records associated with the storage volume.

17. The one or more non-transitory computer-readable storage media of claim 11, wherein the one or more sequences of the program instructions which, when executed by the one or more computing devices, further cause receiving, at the management container, an indication of a second set of service level objectives for the storage volume.

18. The one or more non-transitory computer-readable storage media of claim 11, wherein the operation is selecting new storage devices for the storage volume.

19. The one or more non-transitory computer-readable storage media of claim 11, wherein the operation is allocating new parcels.

20. The one or more non-transitory computer-readable storage media of claim 11, wherein the operation is stopping use of one of the one or more selected storage devices.
